(19) United States
(12) Patent Application Publication
(10) Pub. No.: US 2026/0058552 A1
(43) Pub. Date: Feb. 26, 2026

(54) Control Circuit, Power Supply Circuit, and Electronic Apparatus

(71) Applicant: ROHM CO., LTD., KYOTO (JP)

(72) Inventors: Makoto YASUSAKA, KYOTO (JP); Akihiro KAWANO, KYOTO (JP); Kotaro IWATA, KYOTO (JP); Hiroki INOUE, KYOTO (JP)

(21) Appl. No.: 19/297,427

(22) Filed: Aug. 12, 2025

(30) Foreign Application Priority Data
Aug. 21, 2024 (JP) 2024-139493

(51) Int. Cl. H02M 3/07; G05F 1/565; H02M 3/137

(52) U.S. Cl. CPC H02M 3/072; G05F 1/565; H02M 3/137

(57) ABSTRACT

A control circuit is configured to be used as part of a switched capacitor converter, which includes a plurality of switch elements and at least one capacitor, and is configured to generate a second voltage from a first voltage. The control circuit includes a mode switching circuit configured to switch between a first mode and a second mode. The first mode is a mode in which switching control of the plurality of switch elements is stopped to set the second voltage to a voltage value that can be regarded as the same as the first voltage. The second mode is a mode in which the plurality of switch elements is switching-controlled to set the second voltage to a voltage value lower than the first voltage.

### TECHNICAL FIELD

The present disclosure relates to a control circuit, a power supply circuit, and an electronic apparatus.

### BACKGROUND

Conventionally, linear power supply circuits have been widely known (refer to, for example, Patent Document 1).

### PRIOR ART DOCUMENT

### Patent Document

[Patent document 1] Japan Patent Publication No. 2018-112963.

### BRIEF DESCRIPTION OF THE DRAWINGS

FIG. 1 is a diagram showing a configuration of a power supply circuit according to a first comparative example.

FIG. 2 is an external perspective view of a semiconductor integrated circuit device.

FIG. 3 is a diagram showing a relationship between an input voltage and a loss.

FIG. 4 is a diagram showing a relationship between an input voltage and an output voltage when a linear power supply circuit is used alone.

FIG. 5 is a diagram showing a relationship between an input voltage, an intermediate voltage, and an output voltage in the power supply circuit according to the first comparative example.

FIG. 6 is a diagram showing a configuration of a power supply circuit according to a second comparative example.

FIG. 7 is a diagram showing a configuration of a power supply circuit according to a first embodiment.

FIG. 8 is a diagram showing a state of a MOS transistor, which is a switch element.

FIG. 9 is a diagram showing a state of a MOS transistor, which is a switch element.

FIG. 10 is a diagram showing a first modification example of a mode switching circuit.

FIG. 11 is a diagram showing a second modification example of a mode switching circuit.

FIG. 12 is a diagram showing a third modification example of a mode switching circuit.

FIG. 13 is a diagram showing a fourth modification example of a mode switching circuit.

FIG. 14 is a diagram showing a relationship between an input voltage, an intermediate voltage, and an output voltage in the power supply circuit according to the first embodiment.

FIG. 15 is a diagram showing a relationship between an input voltage and a loss in the power supply circuit according to the first embodiment.

FIG. 16 is a diagram showing a configuration of a power supply circuit according to a second embodiment.

FIG. 17 is a diagram showing a relationship between an input voltage, an intermediate voltage, and an output voltage in the power supply circuit according to the second embodiment.

FIG. 18 is a diagram showing a configuration of a power supply circuit according to a third embodiment.

FIG. 19 is a diagram showing a configuration of a power supply circuit according to a fourth embodiment.

FIG. 20 is a diagram showing load regulation characteristics of an intermediate voltage.

FIG. 21 is a diagram showing a relationship between an input voltage, an intermediate voltage, and an output voltage in a power supply circuit according to the fourth embodiment.

FIG. 22 is a diagram showing a configuration of a power supply circuit according to a fifth embodiment.

FIG. 23 is a diagram showing a configuration of a power supply circuit according to a sixth embodiment.

FIG. 24 is a diagram showing a time transition of an input voltage, an intermediate voltage, and an output voltage.

FIG. 25 is a diagram showing a configuration of a power supply circuit according to a seventh embodiment.

FIG. 26 is a diagram showing a first configuration example of a power supply circuit according to an eighth embodiment.

FIG. 27 is a diagram showing a second configuration example of the power supply circuit according to the eighth embodiment.

FIG. 28 is a diagram showing a third configuration example of the power supply circuit according to the eighth embodiment.

FIG. 29 is an external perspective view of a vehicle.

FIG. 30 is a diagram showing a first modification example of a switched capacitor converter.

FIG. 31 is a diagram showing a second modification example of a switched capacitor converter.

### DETAILED DESCRIPTION OF THE EMBODIMENTS

In this specification, MOSFET (Metal-Oxide-Semiconductor Field Effect Transistor) refers to a field effect transistor whose gate structure is formed of at least three layers, “a layer made of a conductor or a semiconductor such as polysilicon having low resistance,” “an insulating layer,” and “a P-type, N-type, or intrinsic semiconductor layer. ” That is, the gate structure of a MOSFET is not limited to a three-layer structure of metal, oxide, and semiconductor. Hereinafter, a P-channel type MOSFET is referred to as a PMOS transistor, and an N-channel type MOSFET is referred to as an NMOS transistor.

In this specification, a constant voltage refers to a voltage that is constant under ideal conditions, but in practice it is a voltage that may slightly fluctuate due to temperature changes, etc. Furthermore, in this specification, constant voltages with different symbols represent constant voltages of different values.

In this specification, a reference voltage refers to a voltage that is constant under ideal conditions, but in practice it is a voltage that may slightly fluctuate due to temperature changes, etc.

### First Comparative Example

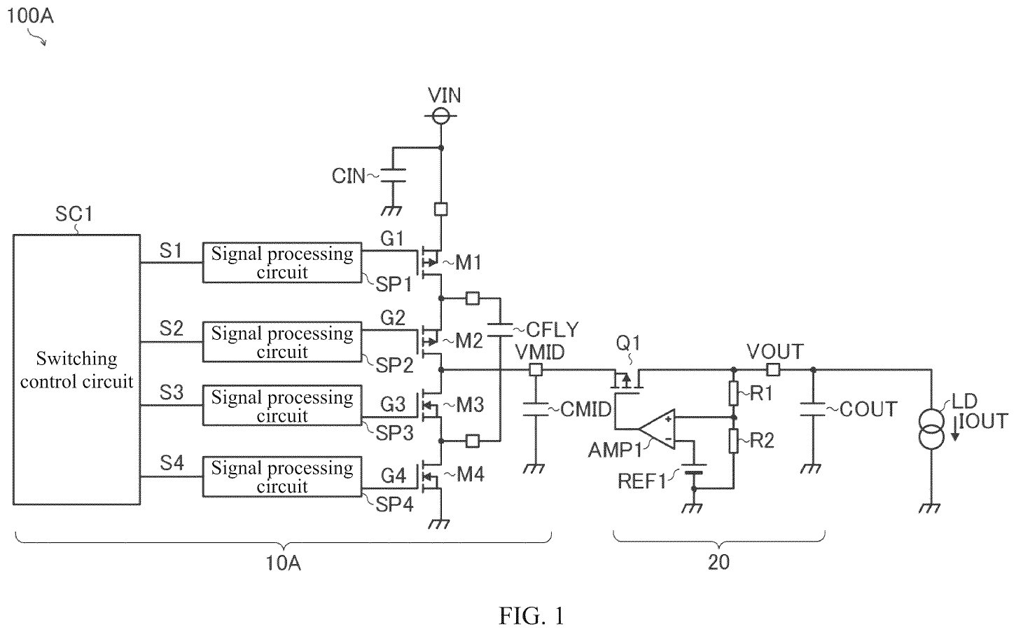

FIG. 1 is a diagram showing a configuration of a power supply circuit according to a first comparative example. A power supply circuit 100A shown in FIG. 1 comprises a switched capacitor converter 10A and a linear power supply circuit 20. The linear power supply circuit 20 is provided at a rear stage of the switched capacitor converter 10A.

The switched capacitor converter 10A is configured to generate an intermediate voltage VMID from an input voltage VIN. The linear power supply circuit 20 is configured to generate an output voltage VOUT from the intermediate voltage VMID.

The switched capacitor converter 10A comprises a switching control circuit SC1, signal processing circuits SP1 to SP4, PMOS transistors M1 and M2 each functioning as switch elements, NMOS transistors M3 and M4 each functioning as switch elements, an input capacitor CIN, a flying capacitor CFLY, and an intermediate capacitor CMID.

The input voltage VIN is applied to a first terminal of the input capacitor CIN and a source of the PMOS transistor M1. A second terminal of the input capacitor CIN is connected to a ground potential. The input voltage VIN is smoothed by the input capacitor CIN. A drain of the PMOS transistor M1 is connected to a source of the PMOS transistor M2 and a first terminal of the flying capacitor CFLY. A drain of the PMOS transistor M2 is connected to a drain of the NMOS transistor M3, a first terminal of the intermediate capacitor CMID, and a source of a PMOS transistor Q1 described below. A source of the NMOS transistor M3 is connected to a drain of the NMOS transistor M4 and a second terminal of the flying capacitor CFLY. A source of the NMOS transistor M4 and a second terminal of the intermediate capacitor CMID are connected to the ground potential.

The switching control circuit SC1 generates control signals S1 to S4. The switching control circuit SC1 outputs a HIGH-level control signal S1 when the PMOS transistor M1 is turned on and outputs a LOW-level control signal S1 when the PMOS transistor M1 is turned off. The switching control circuit SC1 outputs a HIGH-level control signal S2 when the PMOS transistor M2 is turned on and outputs a LOW-level control signal S2 when the PMOS transistor M2 is turned off. The switching control circuit SC1 outputs a HIGH-level control signal S3 when the NMOS transistor M3 is turned on and outputs a LOW-level control signal S3 when the NMOS transistor M3 is turned off. The switching control circuit SC1 outputs a HIGH-level control signal S4 when the NMOS transistor M4 is turned on and outputs a LOW-level control signal S4 when the NMOS transistor M4 is turned off.

Each of the signal processing circuits SP1 to SP4 includes a level shifter and a driver. The signal processing circuit SP1 generates a gate signal G1 by level shifting, logically inverting, and power amplifying the control signal S1, and supplies it to a gate of the PMOS transistor M1. The signal processing circuit SP2 generates a gate signal G2 by level shifting, logically inverting, and power amplifying the control signal S2, and supplies it to a gate of the PMOS transistor M2. The signal processing circuit SP3 generates a gate signal G3 by level shifting and power amplifying the control signal S3, and supplies it to a gate of the NMOS transistor M3. The signal processing circuit SP4 generates a gate signal G4 by level shifting and power amplifying the control signal S4, and supplies it to a gate of the NMOS transistor M4.

By a switching control of the switching control circuit SC1, a first state and a second state are repeated, and an intermediate voltage VMID that is ½ of the input voltage VIN is generated.

In the first state, the PMOS transistor M1 and the NMOS transistor M3 are turned on, and the PMOS transistor M2 and the NMOS transistor M4 are turned off, thereby connecting the flying capacitor CFLY and the intermediate capacitor CMID in series.

In the second state, the PMOS transistor M1 and the NMOS transistor M3 are turned off, and the PMOS transistor M2 and the NMOS transistor M4 are turned on, thereby connecting the flying capacitor CFLY and the intermediate capacitor CMID in parallel.

The linear power supply circuit 20 comprises the PMOS transistor Q1 functioning as a variable resistor, an output capacitor COUT, resistors R1 and R2, a reference voltage source REF1, and an error amplifier AMP1.

The intermediate voltage VMID output from the switched capacitor converter 10A is applied to a source of the PMOS transistor Q1. A drain of the PMOS transistor Q1 is connected to a first terminal of the resistor R1, a first terminal of the output capacitor COUT, and a first terminal of a load LD. A second terminal of the resistor R1 is connected to a first terminal of the resistor R2 and a non-inverting input terminal of the error amplifier AMP1. A positive electrode of the reference voltage source REF1 is connected to an inverting input terminal of the error amplifier AMP1. An output terminal of the error amplifier AMP1 is connected to a gate of the PMOS transistor Q1. A second terminal of the output capacitor COUT, a second terminal of the resistor R2, a negative electrode of the reference voltage source REF1, and a second terminal of the load LD are connected to the ground potential.

The output voltage VOUT, which is a drain voltage of the PMOS transistor Q1, is a voltage that drops by a source-drain voltage of the PMOS transistor Q1 from the intermediate voltage VMID. The output voltage VOUT is smoothed by the output capacitor COUT.

The voltage divider circuit comprising the resistors R1 and R2 generates a divided voltage of the output voltage VOUT and supplies it to a non-inverting input terminal of the error amplifier AMP1.

The error amplifier AMP1 generates an error signal corresponding to an error between the divided voltage of the output voltage VOUT and a reference voltage output from the reference voltage source REF1, and supplies it to the gate of the PMOS transistor Q1.

The output voltage VOUT output from the linear power supply circuit 20 is applied to a first terminal of the load LD.

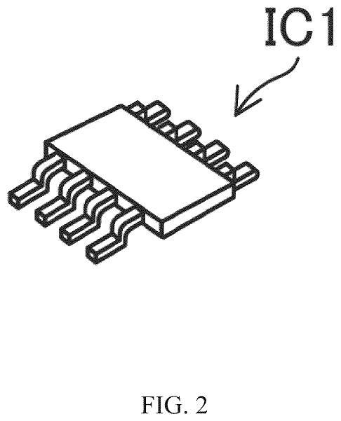

The PMOS transistors M1 and M2, the NMOS transistors M3 and M4, the switching control circuit SC1, the signal processing circuits SP1 to SP4, the PMOS transistor Q1, the resistors R1 and R2, the reference voltage source REF1, and the error amplifier AMP1 are mounted, for example, on a semiconductor integrated circuit device IC1 shown in FIG. 2.

The input capacitor CIN, the flying capacitor CFLY, the intermediate capacitor CMID, and the output capacitor COUT are external components of the semiconductor integrated circuit device IC1.

The semiconductor integrated circuit device IC1 is an electronic component comprising a semiconductor chip that comprises a semiconductor integrated circuit formed on a semiconductor substrate, a housing (package) that accommodates the semiconductor chip, and multiple external terminals exposed to an outside of the semiconductor integrated circuit device IC1 from the housing. The semiconductor integrated circuit device IC1 is formed by enclosing the semiconductor chip within a housing (package) comprising resin. Furthermore, a number of the external terminals of the semiconductor integrated circuit device IC1 and a type of the housing of the semiconductor integrated circuit device IC1 shown in FIG. 2 are merely exemplary and can be designed arbitrarily.

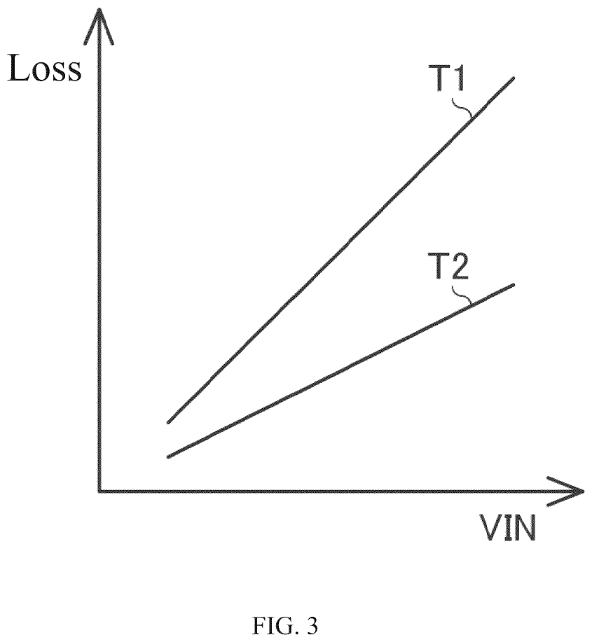

FIG. 3 is a diagram showing a relationship between the input voltage VIN and a loss when a current IOUT flowing through a load LD1 is fixed. A characteristic line T1 shows the relationship between the input voltage VIN and a loss when the linear power supply circuit 20 is used alone. When the linear power supply circuit 20 is used alone, the input voltage VIN is applied to the source of the PMOS transistor Q1. A characteristic line T2 shows a relationship between the input voltage VIN and a loss of the power supply circuit 100A. Since the intermediate voltage VMID supplied to the linear power supply circuit 20 of the power supply circuit 100A is ½ of the input voltage VIN, the loss of the power supply circuit 100A can be reduced to approximately half of the loss when the linear power supply circuit 20 is used alone.

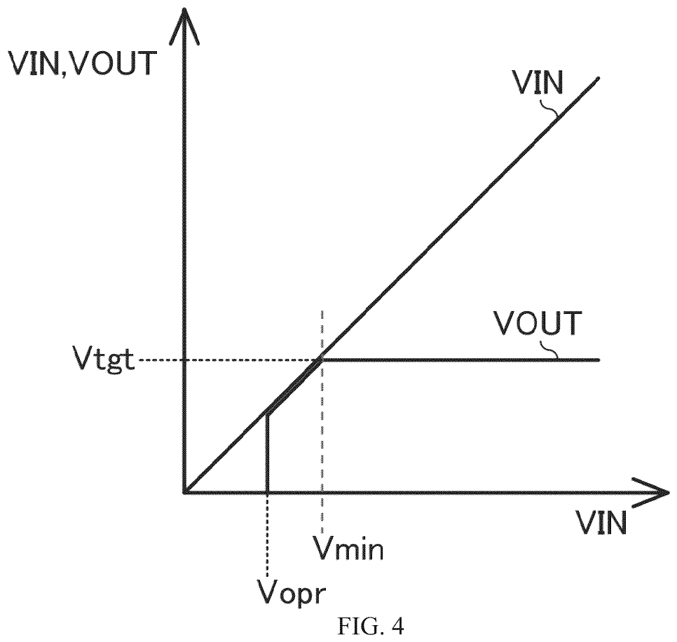

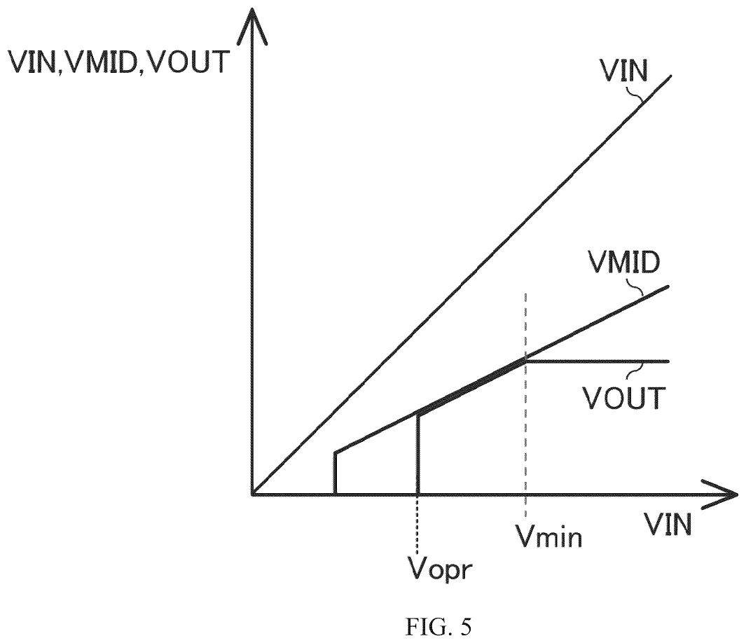

However, in the power supply circuit 100A, since the intermediate voltage VMID supplied to the linear power supply circuit 20 of the power supply circuit 100A is ½ of the input voltage VIN, compared to when the linear power supply circuit 20 is used alone, the input voltage at which the circuit can operate, i.e., a startup voltage Vopr, and an input voltage Vmin at which the output voltage VOUT can be output as per a set voltage, each requires twice the magnitude (refer to FIG. 4 and FIG. 5). Furthermore, FIG. 4 is a diagram showing a relationship between the input voltage VIN and the output voltage YOUT when the linear power supply circuit 20 is used alone. Additionally, FIG. 5 is a diagram showing a relationship between the input voltage VIN, the intermediate voltage VMID, and the output voltage VOUT in the power supply circuit 100A.

### Second Comparative Example

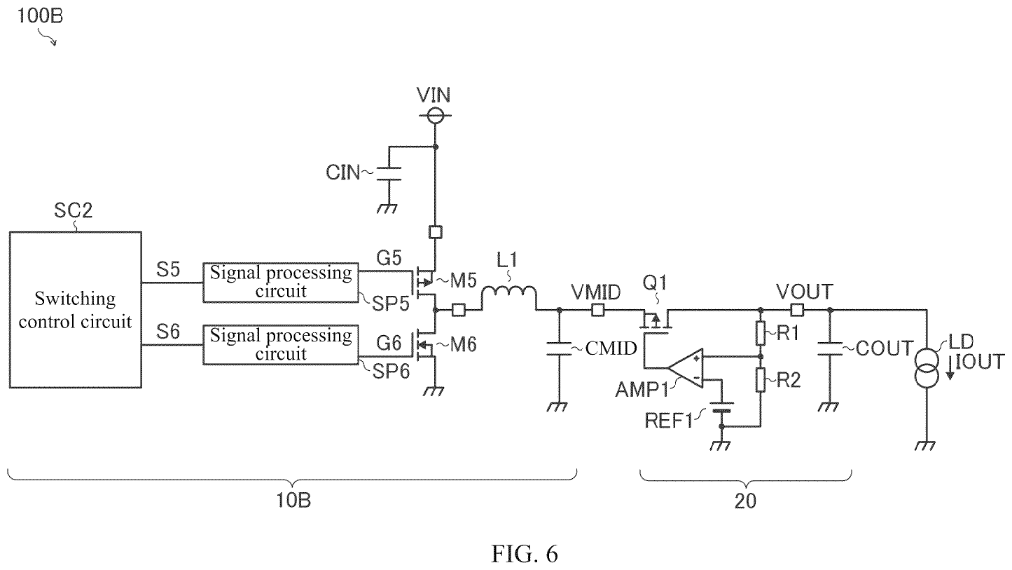

FIG. 6 is a diagram showing a configuration of a power supply circuit according to a second comparative example. In FIG. 6, the same parts as those in FIG. 1 are denoted by the same reference numerals, and detailed illustrations thereof are omitted.

A power supply circuit 100B shown in FIG. 6 is configured such that the switched capacitor converter 10A in the power supply circuit 100A shown in FIG. 1 is replaced with a DC/DC converter 10B.

The DC/DC converter 10B is configured to generate an intermediate voltage VMID from the input voltage VIN.

The DC/DC converter 10B comprises a switching control circuit SC2, signal processing circuits SP5 and SP6, a PMOS transistor M5 functioning as a switching element, an NMOS transistor M6 functioning as a switching element, an input capacitor CIN, a coil L1, and an intermediate capacitor CMID.

The input voltage VIN is applied to the first terminal of the input capacitor CIN and a source of the PMOS transistor M5. The second terminal of the input capacitor CIN is connected to the ground potential. The drain of the PMOS transistor M5 is connected to a drain of the NMOS transistor M6 and a first terminal of the coil. A second terminal of the coil is connected to the first terminal of the intermediate capacitor CMID and the source of the PMOS transistor Q1. The source of the NMOS transistor M2 and the second terminal of the intermediate capacitor CMID are connected to the ground potential.

The switching control circuit SC2 generates control signals S5 and S6. The switching control circuit SC2 outputs a HIGH-level control signal S5 when the PMOS transistor M5 is turned on and outputs a LOW-level control signal S5 when the PMOS transistor M5 is turned off. The switching control circuit SC2 outputs a HIGH-level control signal S6 when the NMOS transistor M6 is turned on and outputs a LOW-level control signal S6 when the NMOS transistor M6 is turned off.

Each of the signal processing circuits SP5 and SP6 includes a level shifter and a driver. The signal processing circuit SP5 generates a gate signal G5 by level-shifting, logically inverting, and power amplifying the control signal S5, and supplies it to the gate of the PMOS transistor M5. The signal processing circuit SP6 generates a gate signal G6 by level-shifting and power amplifying the control signal S6, and supplies it to the gate of the NMOS transistor M6.

By switching control of the switching control circuit SC1, the PMOS transistor M5 and the NMOS transistor M6 are turned on/off complementarily. When an on-duty of each of the control signals S5 and S6 is 50%, an intermediate voltage VMID, which is ½ of the input voltage VIN, is generated.

The PMOS transistor M5, the NMOS transistor M6, the switching control circuit SC2, the signal processing circuits SP5 and SP6, the PMOS transistor Q1, the resistors R1 and R2, the reference voltage source REF1, and the error amplifier AMP1 are mounted on a semiconductor integrated circuit device.

The input capacitor CIN, the coil L1, the intermediate capacitor CMID, and the output capacitor COUT are external components of the semiconductor integrated circuit device.

Although the power supply circuit 100B has fewer number of switching elements than the power supply circuit 100A, since it is configured to comprise the coil L1, it is inferior to the power supply circuit 100A in terms of space saving and cost reduction. The switching elements do not require high on-resistance, can be made smaller in size, and can be incorporated into the semiconductor integrated circuit device. Thus, in the power supply circuit 100B, a disadvantage of requiring the coil L1 outweighs an advantage of being able to reduce the number of switching elements.

### First Embodiment

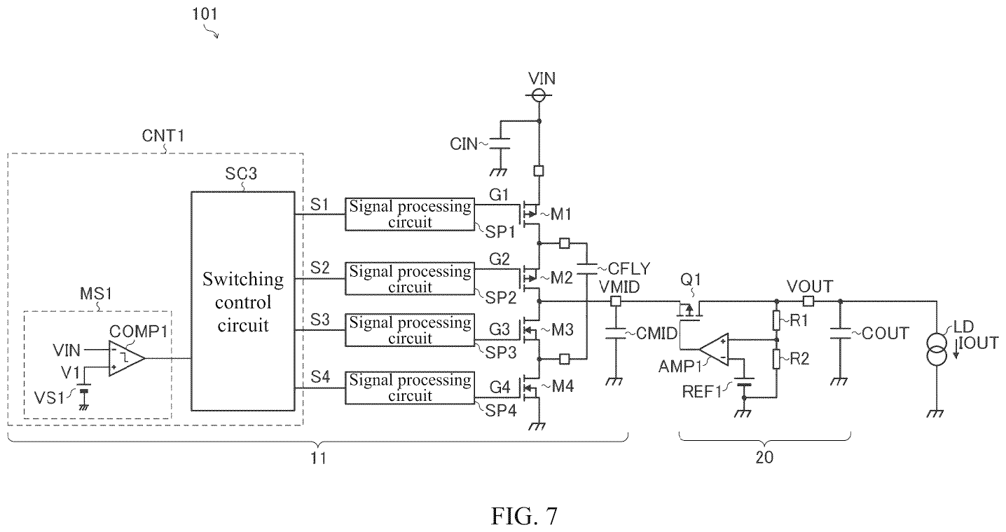

FIG. 7 is a diagram showing a configuration of a power supply circuit according to a first embodiment. In FIG. 7, the same parts as those in FIG. 1 are denoted by the same reference numerals, and detailed illustrations are omitted.

A power supply circuit 101 shown in FIG. 7 is configured such that the switched capacitor converter 10A in the power supply circuit 100A shown in FIG. 1 is replaced with a switched capacitor converter 11. That is, the power supply circuit 101 comprises the switched capacitor converter 11 and a linear power supply circuit 20 provided at a rear stage of the switched capacitor converter 11.

The switched capacitor converter 11 is configured such that the switching control circuit SC1 in the switched capacitor converter 10A shown in FIG. 1 is replaced with a control circuit CNT1. Furthermore, the switched capacitor converter 11 may adopt a configuration where it does not comprise the input capacitor CIN.

The PMOS transistors M1 and M2, the NMOS transistors M3 and M4, the control circuit CNT1, the signal processing circuits SP1 to SP4, the PMOS transistor Q1, the resistors R1 and R2, the reference voltage source REF1, and the error amplifier AMP1 are mounted on a semiconductor integrated circuit device IC1, as shown in FIG. 2, for example. Furthermore, the semiconductor integrated circuit device provided in the power supply circuit 101 does not have to be a single device. For example, a first semiconductor integrated circuit device that mounts the PMOS transistors M1 and M2, the NMOS transistors M3 and M4, the control circuit CNT1, and the signal processing circuits SP1 to SP4, and a second semiconductor integrated circuit device that mounts the PMOS transistor Q1, the resistors R1 and R2, the reference voltage source REF1, and the error amplifier AMP1 may be provided. Additionally, for example, the semiconductor integrated circuit device that mounts the control circuit CNT1 may not mount the PMOS transistors M1 and M2 and the NMOS transistors M3 and M4.

The control circuit CNT1 comprises a mode switching circuit MS1 and a switching control circuit SC3.

The mode switching circuit MS1 is configured to switch between a pass-through mode and an SCC (Switched Capacitor Converter) mode. The pass-through mode is a mode in which the switching control of the PMOS transistors M1 and M2 and the NMOS transistors M3 and M4 is stopped to set the intermediate voltage VMID to a voltage value that can be regarded as the same as the input voltage VIN. The SCC mode is a mode in which the PMOS transistors M1 and M2 and the NMOS transistors M3 and M4 are switching-controlled to set the intermediate voltage VMID to a voltage value lower than the input voltage VIN (in this embodiment, ½ of the input voltage VIN).

The mode switching circuit MS1 comprises a constant voltage source VS1 and a comparator COMP1.

The comparator COMP1 outputs a HIGH-level comparison result signal if the input voltage VIN is equal to or less than the constant voltage V1 output from the constant voltage source VS1. The switching control circuit SC3 enters the pass-through mode upon receiving the HIGH-level comparison result signal.

The comparator COMP1 outputs a LOW-level comparison result signal if the input voltage VIN is greater than the constant voltage V1 output from the constant voltage source VS1. The switching control circuit SC3 enters the SCC mode upon receiving the LOW-level comparison result signal.

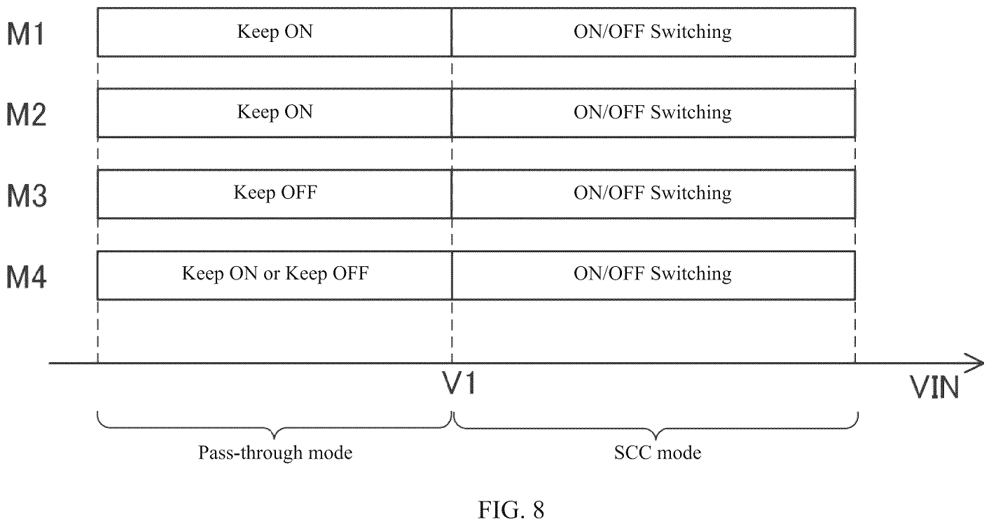

In the pass-through mode, as shown in FIG. 8, the switching control circuit SC3 keeps the PMOS transistor M1 at the ON state, keeps the PMOS transistor M2 at the ON state, keeps the NMOS transistor M3 at the OFF state, and keeps the NMOS transistor M4 at either the ON or OFF state. Furthermore, when the NMOS transistor M4 is kept at the ON state, the flying capacitor CFLY functions as a capacitor that stabilizes the input voltage VIN.

In the SCC mode, as shown in FIG. 8, the switching control circuit SC3 switching-controls the PMOS transistors M1 and M2 and the NMOS transistors M3 and M4. As a result, an intermediate voltage VMID, which is ½ of the input voltage VIN, is generated. More specifically, through the switching control of the switching control circuit SC3, the first state ST1 and the second state ST2 are repeated, and an intermediate voltage VMID, which is ½ of the input voltage VIN, is generated.

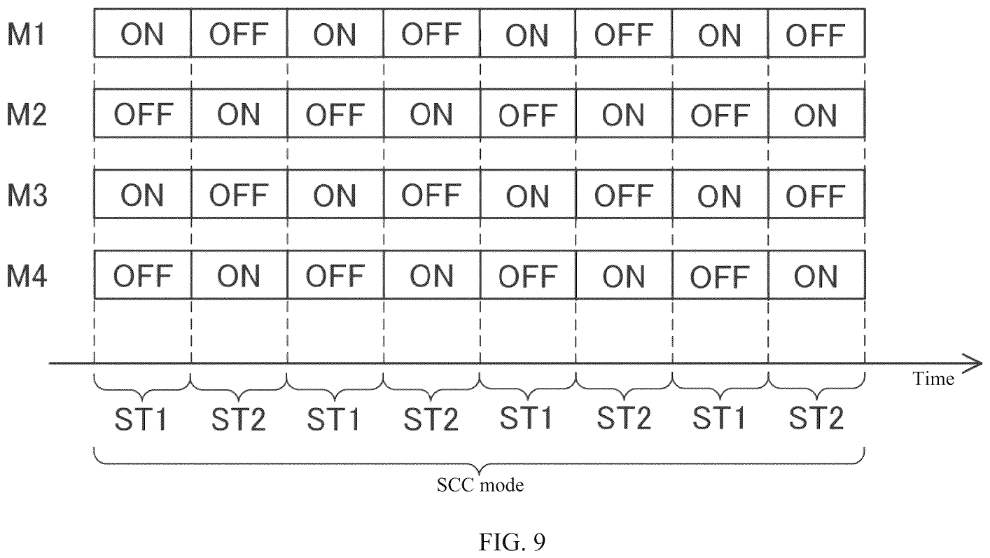

As shown in FIG. 9, in the first state ST1, the PMOS transistor M1 and the NMOS transistor M3 are turned on, and the PMOS transistor M2 and the NMOS transistor M4 are turned off. As a result, the flying capacitor CFLY and the intermediate capacitor CMID are connected in series.

As shown in FIG. 9, in the second state ST2, the PMOS transistor M1 and the NMOS transistor M3 are turned off, and the PMOS transistor M2 and the NMOS transistor M4 are turned on. As a result, the flying capacitor CFLY and the intermediate capacitor CMID are connected in parallel.

The comparator COMP1 of the mode switching circuit MS1 may be configured not to directly detect the input voltage VIN. That is, the comparator COMP1 of the mode switching circuit MS1 may be configured to detect a voltage dependent on the input voltage VIN and indirectly detect the input voltage VIN.

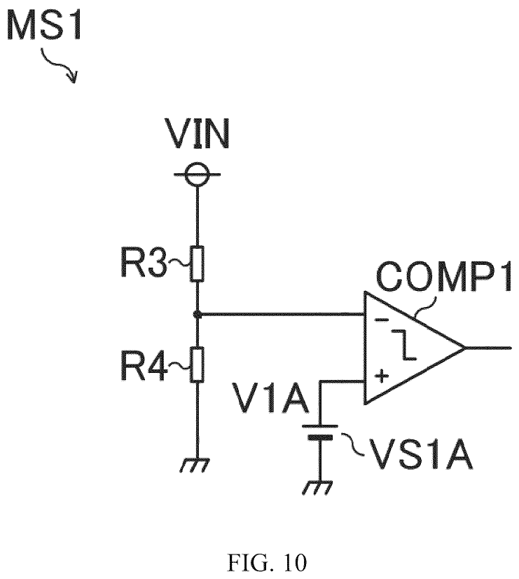

FIG. 10 to FIG. 13 are respective examples of the mode switching circuit MS1 when the comparator COMP1 is configured to indirectly detect the input voltage VIN. Furthermore, a configuration of the mode switching circuit MS1 when the comparator COMP1 is configured to indirectly detect the input voltage VIN is not limited to the respective examples in FIG. 10 to FIG. 13.

The mode switching circuit MS1 shown in FIG. 10 comprises resistors R3 and R4, a constant voltage source VS1A that outputs a constant voltage V1A, and a comparator COMP1.

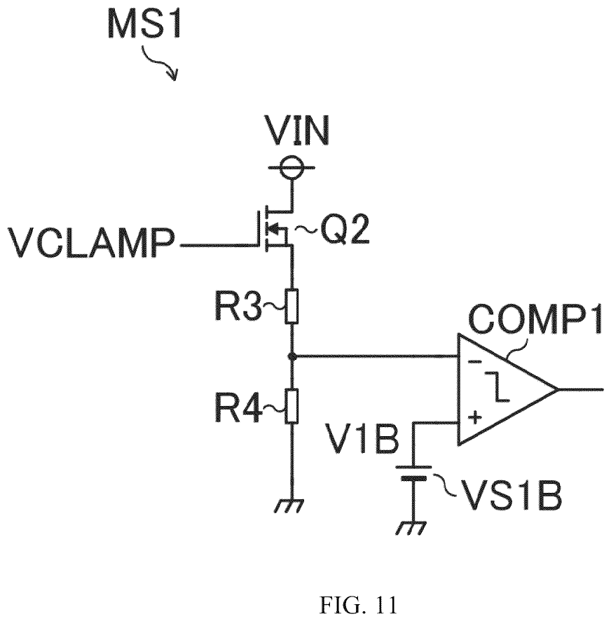

The mode switching circuit MS1 shown in FIG. 11 comprises an NMOS transistor Q2 with a constant voltage VCLAMP applied to its gate, resistors R3 and R4, a constant voltage source VS1B that outputs a constant voltage V1B, and a comparator COMP1.

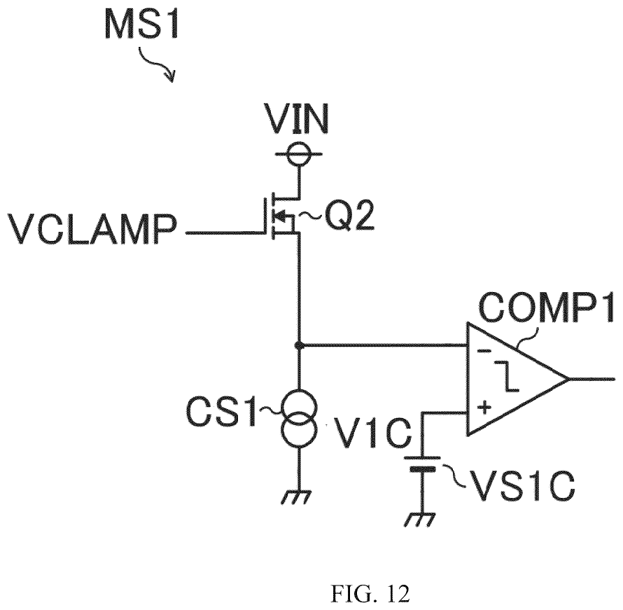

The mode switching circuit MS1 shown in FIG. 12 comprises an NMOS transistor Q2 with the constant voltage VCLAMP applied to its gate, a constant current source CS1 that outputs a constant current, a constant voltage source VS1C that outputs a constant voltage V1C, and a comparator COMP1.

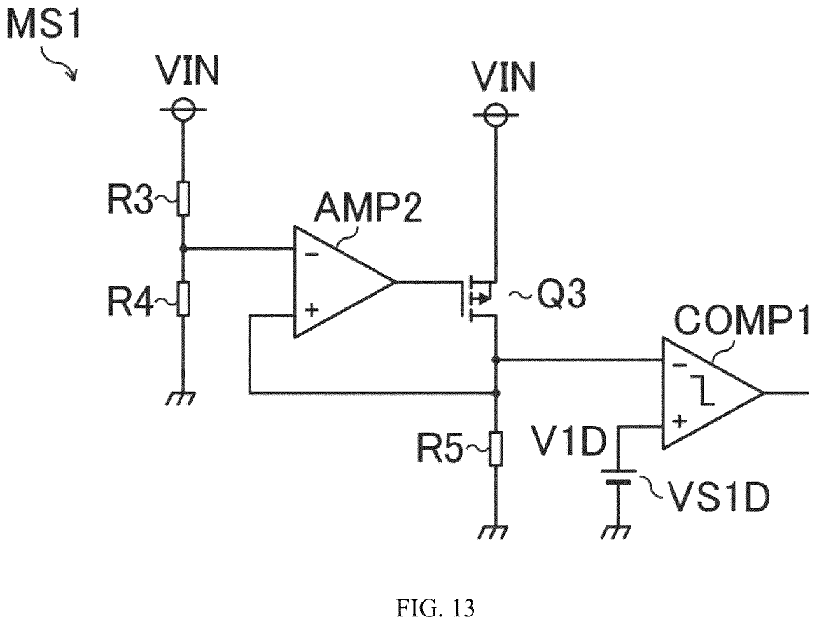

The mode switching circuit MS1 shown in FIG. 13 comprises resistors R3 and R4, an error amplifier AMP2, a PMOS transistor Q3, a resistor R5, a constant voltage source VS1D that outputs a constant voltage V1D, and a comparator COMP1.

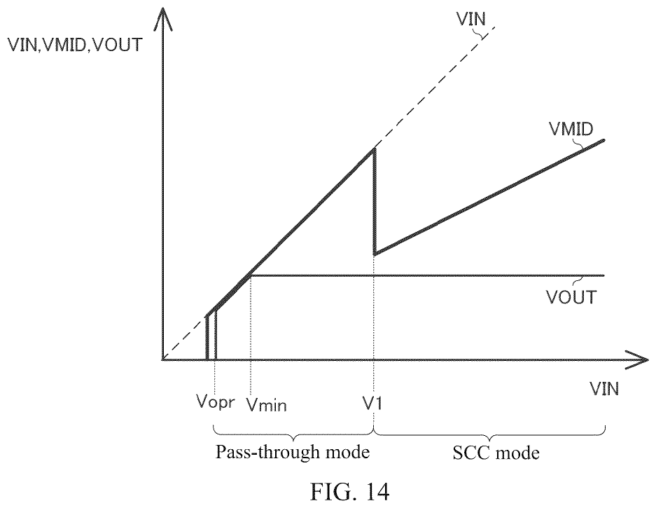

FIG. 14 is a diagram showing a relationship between the input voltage VIN, the intermediate voltage VMID, and the output voltage VOUT in the power supply circuit 101. When the input voltage VIN is equal to or less than the constant voltage V1, the pass-through mode is entered, and the intermediate voltage VMID becomes a voltage value that can be regarded as the same as the input voltage VIN. As a result, the power supply circuit 101 can suppress an increase in the startup voltage Vopr and an increase in the input voltage Vmin at which the output voltage VOUT can be output as per the set voltage.

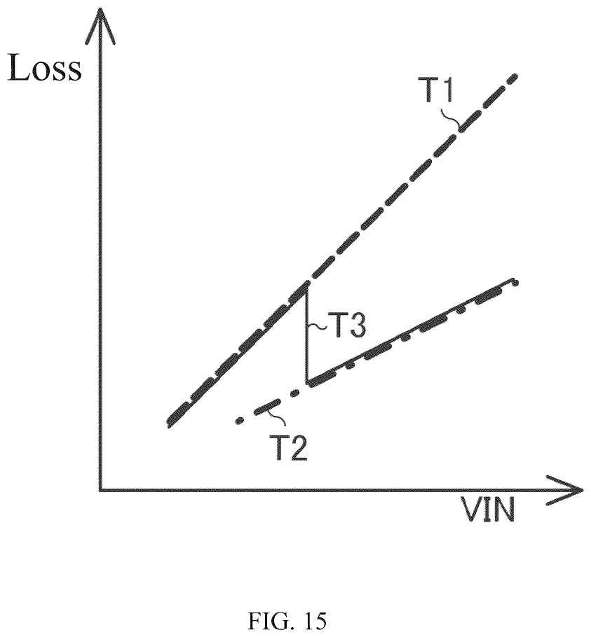

FIG. 15 is a diagram showing a relationship between the input voltage VIN and a loss of the power supply circuit 101. A characteristic line T1 shows a relationship between the input voltage VIN and a loss when the linear power supply circuit 20 is used alone. When the linear power supply circuit 20 is used alone, the input voltage VIN is applied to the source of the PMOS transistor Q1. A characteristic line T2 shows a relationship between the input voltage VIN and the loss of the power supply circuit 100A shown in FIG. 1. A characteristic line T3 shows a relationship between the input voltage VIN and the loss of the power supply circuit 101.

When the input voltage VIN is greater than the constant voltage V1, the SCC mode is entered, and the intermediate voltage VMID becomes ½ of the input voltage VIN. As a result, the loss in the power supply circuit 101 can be reduced to approximately half of the loss when using the linear power supply circuit 20 alone in SCC mode.

As is clear from FIG. 14 and FIG. 15, if the value of the constant voltage V1 is appropriately set, the power supply circuit 101 can perform the same power reduction operation as when using the linear power supply circuit 20 alone, and a maximum value of loss can be suppressed to the same level as the power supply circuit 100A shown in FIG. 1.

### Second Embodiment

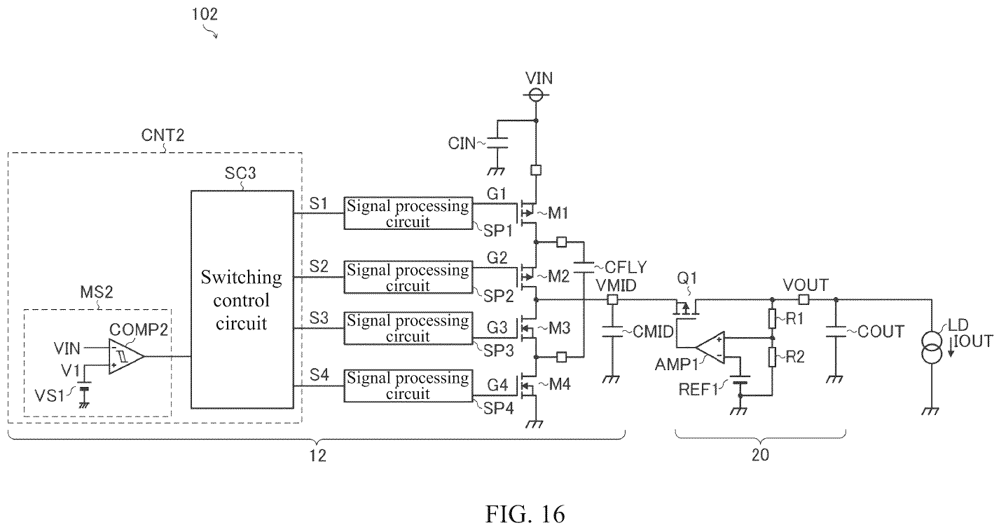

FIG. 16 shows a configuration of a power supply circuit according to a second embodiment. In FIG. 16, the same parts as those in FIG. 7 are denoted by the same reference numerals, and detailed illustrations are omitted.

A power supply circuit 102 shown in FIG. 16 is configured by replacing the switched capacitor converter 11 in the power supply circuit 101 shown in FIG. 7 with a switched capacitor converter 12. That is, the power supply circuit 102 comprises the switched capacitor converter 12 and a linear power supply circuit 20 provided at a rear stage of the switched capacitor converter 12.

The switched capacitor converter 12 is configured by replacing the control circuit CNT1 in the switched capacitor converter 11 shown in FIG. 7 with a control circuit CNT2. The control circuit CNT2 is configured by replacing the mode switching circuit MS1 in the control circuit CNT1 shown in FIG. 7 with a mode switching circuit MS2.

The mode switching circuit MS2 comprises a constant voltage source VS1 and a comparator COMP2 having a hysteresis function.

The comparator COMP2 switches a level of a comparison result signal from a LOW level to a HIGH level when the input voltage VIN becomes greater than the constant voltage V1 from being less than or equal to the constant voltage V1.

The comparator COMP2 switches the level of the comparison result signal from the HIGH level to the LOW level when the input voltage VIN becomes less than or equal to a constant voltage (V1−α) from being greater than the constant voltage (V1−α). Furthermore, the constant voltage (V1−α) is a voltage lower than the constant voltage V1.

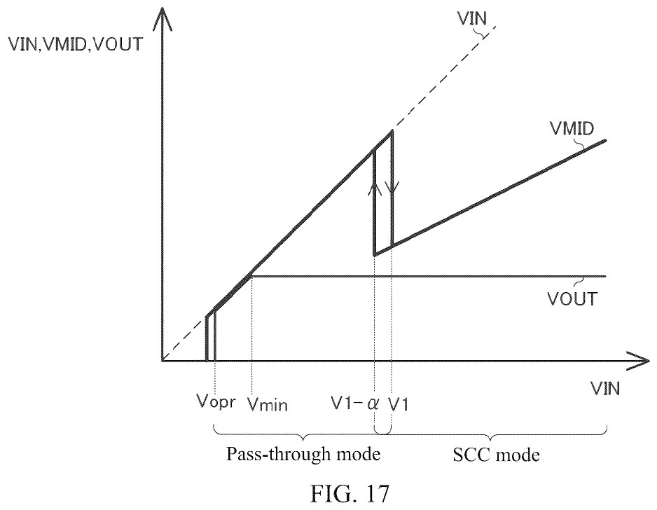

FIG. 17 is a diagram showing a relationship between the input voltage VIN, the intermediate voltage VMID, and the output voltage VOUT in the power supply circuit 102.

When switching between pass-through mode and SCC mode, there is a possibility of noise occurring in the constant voltage source VS1 due to fluctuations in the input voltage VIN and fluctuations in the intermediate voltage VMID. To suppress unnecessary switching between the pass-through mode and the SCC mode due to adverse effects of this noise, it is preferable to provide hysteresis in switching between the pass-through mode and the SCC mode as in this embodiment.

### Third Embodiment

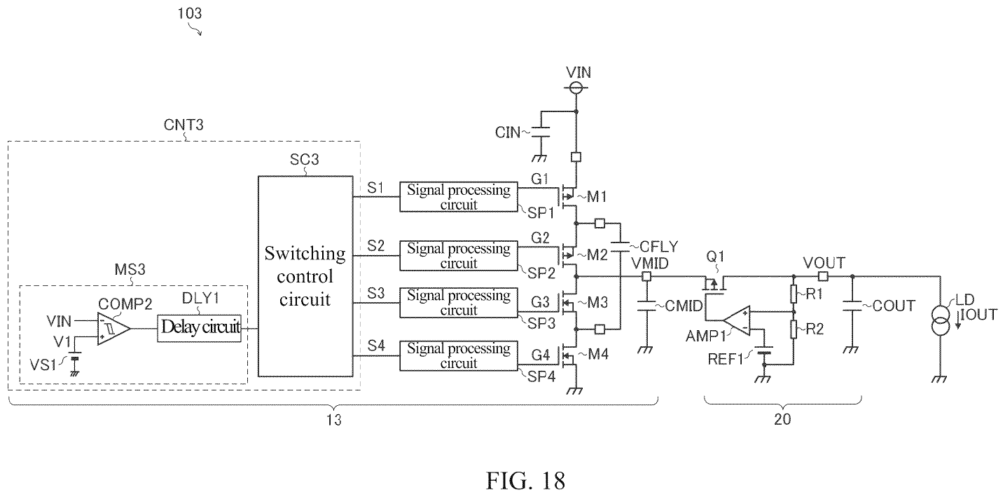

FIG. 18 is a diagram showing a configuration of a power supply circuit according to a third embodiment. In FIG. 18, the same parts as those in FIG. 16 are denoted by the same reference numerals, and detailed illustrations are omitted.

A power supply circuit 103 shown in FIG. 18 is configured by replacing the switched capacitor converter 12 in the power supply circuit 102 shown in FIG. 16 with a switched capacitor converter 13. That is, the power supply circuit 103 comprises the switched capacitor converter 13 and a linear power supply circuit 20 provided at a rear stage of the switched capacitor converter 13.

The switched capacitor converter 13 is configured by replacing the control circuit CNT2 in the switched capacitor converter 12 shown in FIG. 16 with a control circuit CNT3. The control circuit CNT3 is configured by replacing the mode switching circuit MS2 in the control circuit CNT2 shown in FIG. 16 with a mode switching circuit MS3.

The mode switching circuit MS3 is configured to provide a delay in mode switching. The mode switching circuit MS3 comprises a constant voltage source VS1, a comparator COMP2 having a hysteresis function, and a delay circuit DLY1.

The delay circuit DLY1 supplies a delay signal obtained by delaying a comparison result signal output from the comparator COMP2 to the switching control circuit SC3.

In the power supply circuit 103, a delay is provided in the mode switching, so that unnecessary switching between the pass-through mode and the SCC mode due to adverse effects of noise is suppressed.

Furthermore, in this embodiment, although the delay circuit DLY1 is provided at a rear stage of the comparator COMP2 having a hysteresis function, a signal transmission time of the comparison result signal may be controlled internally within the switching control circuit SC3 without the delay circuit DLY1 being provided.

Additionally, a comparator without a hysteresis function may be used instead of the comparator COMP2 having a hysteresis function.

Additionally, a delay may be provided for both the mode switching from the pass-through mode to the SCC mode and the mode switching from the SCC mode to the pass-through mode, or a delay may be provided for only one of the mode switching from the pass-through mode to the SCC mode and the mode switching from the SCC mode to the pass-through mode.

### Fourth Embodiment

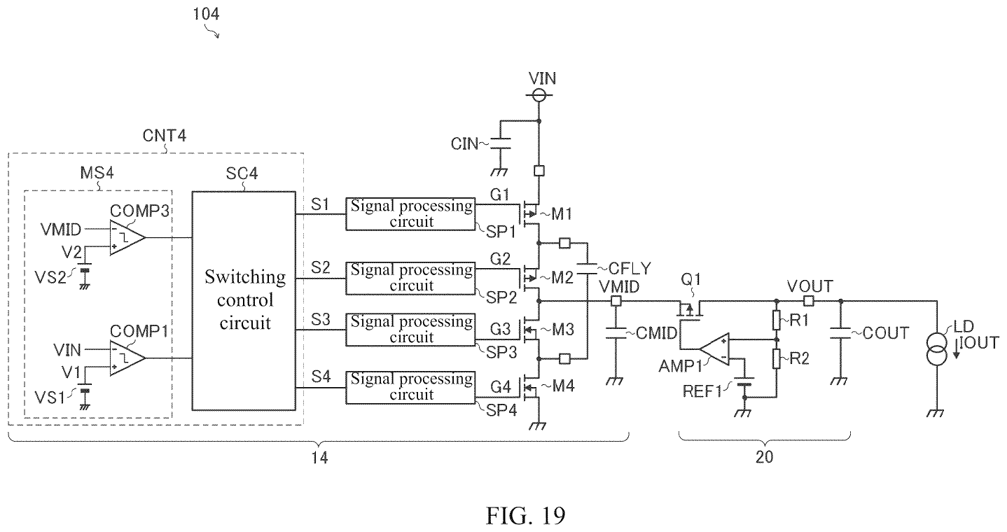

FIG. 19 is a diagram showing a configuration of a power supply circuit according to a fourth embodiment. In FIG. 19, the same parts as those in FIG. 7 are denoted by the same reference numerals, and detailed illustrations are omitted.

A power supply circuit 104 shown in FIG. 19 is configured by replacing the switched capacitor converter 11 in the power supply circuit 101 shown in FIG. 7 with a switched capacitor converter 14. That is, the power supply circuit 104 comprises the switched capacitor converter 14 and a linear power supply circuit 20 provided at a rear stage of the switched capacitor converter 14.

The switched capacitor converter 14 is configured by replacing the control circuit CNT1 in the switched capacitor converter 11 shown in FIG. 7 with a control circuit CNT4.

The control circuit CNT4 comprises a mode switching circuit MS4 and a switching control circuit SC4.

The mode switching circuit MS4 is configured to execute mode switching from the pass-through mode to the SCC mode and mode switching from the SCC mode to the pass-through mode according to different voltages. More specifically, the mode switching circuit MS4 is configured to switch from the pass-through mode to the SCC mode according to the input voltage VIN and mode switching from the SCC mode to the pass-through mode according to the intermediate voltage VMID.

The mode switching circuit MS4 comprises constant voltage sources VS1 and VS2, and comparators COMP1 and COMP3.

The comparator COMP1 outputs a HIGH-level comparison result signal if the input voltage VIN is less than or equal to the constant voltage V1 output from the constant voltage source VS1. The comparator COMP1 outputs a LOW-level comparison result signal if the input voltage VIN is greater than the constant voltage V1 output from the constant voltage source VS1.

The comparator COMP3 outputs a HIGH-level comparison result signal if the intermediate voltage VMID is less than or equal to the constant voltage V2 output from the constant voltage source VS2. The comparator COMP3 outputs a LOW-level comparison result signal if the intermediate voltage VMID is greater than the constant voltage V2 output from the constant voltage source VS2.

The switching control circuit SC4 controls the PMOS transistors M1 and M2 and the NMOS transistors M3 and M4 to switch from the pass-through mode to the SCC mode when a level of the comparison result signal output from the comparator COMP1 switches from a HIGH level to a LOW level.

The switching control circuit SC4 controls the PMOS transistors M1 and M2 and the NMOS transistors M3 and M4 to switch from the SCC mode to the pass-through mode when the level of the comparison result signal output from the comparator COMP3 switches from a LOW level to a HIGH level.

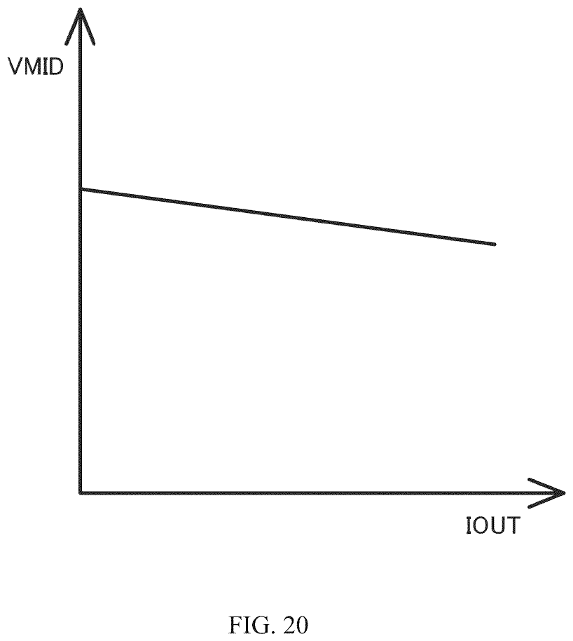

In the switched capacitor converter 14, when the intermediate voltage VMID is given load regulation characteristics as shown in FIG. 20, the intermediate voltage VMID decreases in response to an increase in a current IOUT flowing through the load LD1, even if the input voltage VIN does not change.

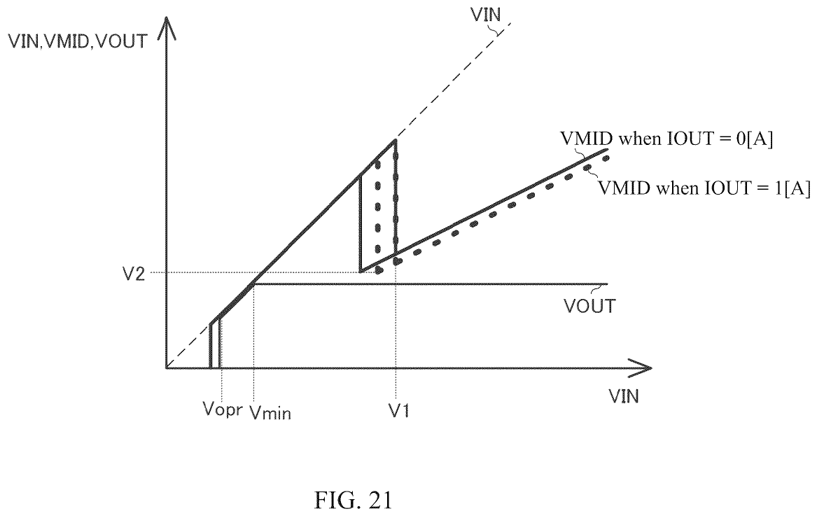

Thus, if the switching from the SCC mode to the pass-through mode is also executed according to the input voltage VIN, the constant voltage V1 is set higher in consideration of decrease in the intermediate voltage VMID due to load regulation characteristics. On the other hand, as in this embodiment, if the switching from the SCC mode to the pass-through mode is executed according to the intermediate voltage VMID, it becomes possible to switch from the SCC mode to the pass-through mode at an intermediate voltage VMID that is optimal for the linear power supply circuit 20, as shown in FIG. 21. As a result, when the intermediate voltage VMID is given load regulation characteristics as shown in FIG. 20, the power supply circuit 103 can achieve lower loss compared to the power supply circuit 101.

Furthermore, in this embodiment, a comparator having a hysteresis function may also be used instead of the comparator COMP1. Additionally, a comparator having a hysteresis function may also be used instead of the comparator COMP3. Additionally, a delay may also be provided for each comparison result signal.

### Fifth Embodiment

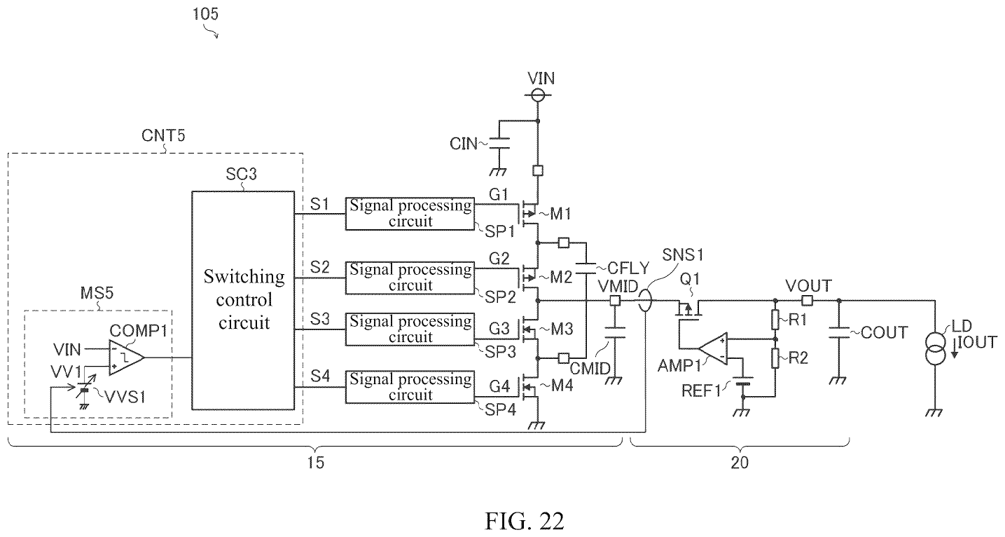

FIG. 22 is a diagram showing a configuration of a power supply circuit according to a fifth embodiment. In FIG. 22, the same parts as those in FIG. 7 are denoted by the same reference numerals, and detailed illustrations are omitted.

A power supply circuit 105 shown in FIG. 22 is configured by replacing the switched capacitor converter 11 in the power supply circuit 101 shown in FIG. 7 with a switched capacitor converter 15. That is, the power supply circuit 105 comprises the switched capacitor converter 15 and a linear power supply circuit 20 provided at a rear stage of the switched capacitor converter 15.

The switched capacitor converter 15 is configured by replacing the control circuit CNT1 in the switched capacitor converter 11 shown in FIG. 7 with a control circuit CNT5.

The control circuit CNT5 is configured by replacing the mode switching circuit MS1 in the control circuit CNT1 shown in FIG. 7 with a mode switching circuit MS5.

The mode switching circuit MS5 is configured by replacing the constant voltage source VS1 in the mode switching circuit MS1 shown in FIG. 7 with a variable voltage source VVS1.

The variable voltage source VVS1 adjusts a value of a variable voltage VV1 according to information of the current IOUT detected by a current detection sensor SNS1 and supplies the variable voltage VV1 to a non-inverting input terminal of the comparator COMP1. As a result, the power supply circuit 105 can achieve similar effects to those of the power supply circuit 104.

In the configuration shown in FIG. 22, the current detection sensor SNS1 is provided on an input side of the linear power supply circuit 20, but it may also be provided on an output side of the linear power supply circuit 20 or an output side of the switched capacitor converter 15.

The current detection sensor SNS1 is configured to include, for example, a mirror PMOS transistor paired with the PMOS transistor Q1 to form a current mirror circuit. A size of the mirror PMOS transistor is smaller than a size of the PMOS transistor Q1, and the mirror current flowing through the mirror PMOS transistor is smaller than the current IOUT flowing through the load LD1.

Furthermore, different than this embodiment, instead of a value of the variable voltage VV1 being adjusted based on the information of the current IOUT detected by the current detection sensor SNS1, the input voltage VIN may be converted at a conversion ratio corresponding to the information of the current IOUT detected by the current detection sensor SNS1 and supplied to the inverting input terminal of the comparator COMP1.

Furthermore, in this embodiment, a comparator having a hysteresis function may also be used instead of the comparator COMP1. Additionally, a delay may also be provided for the comparison result signal.

### Sixth Embodiment

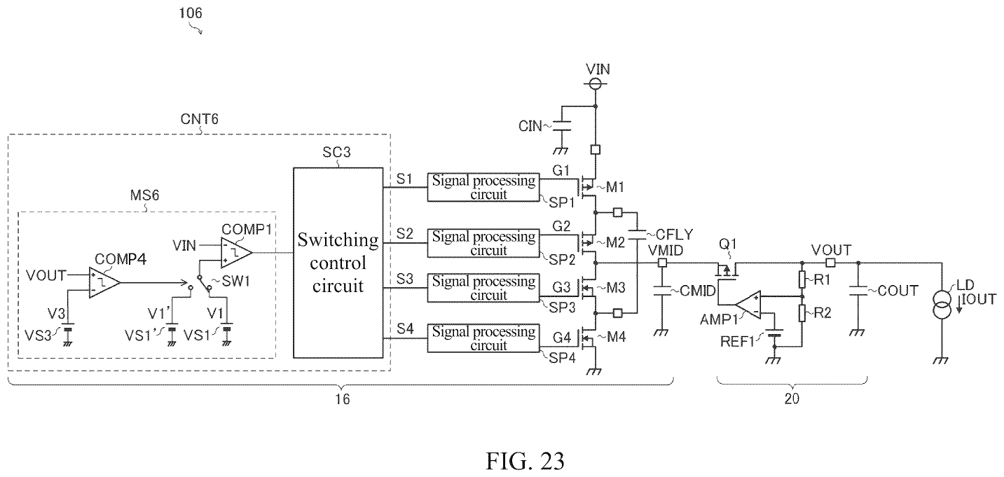

FIG. 23 is a diagram showing a configuration of a power supply circuit according to a sixth embodiment. In FIG. 23, the same parts as those in FIG. 7 are denoted by the same reference numerals, and detailed illustrations are omitted.

A power supply circuit 106 shown in FIG. 23 is configured such that the switched capacitor converter 11 in the power supply circuit 101 shown in FIG. 7 is replaced with a switched capacitor converter 16. That is, the power supply circuit 106 comprises the switched capacitor converter 16 and a linear power supply circuit 20 provided at a rear stage of the switched capacitor converter 16.

The switched capacitor converter 16 is configured such that the control circuit CNT1 in the switched capacitor converter 11 shown in FIG. 7 is replaced with a control circuit CNT6.

The control circuit CNT6 is configured such that the mode switching circuit MS1 in the control circuit CNT1 shown in FIG. 7 is replaced with a mode switching circuit MS6.

The mode switching circuit MS6 is configured such that a switch SW1, a constant voltage source VS1′, a comparator COMP4, and a constant voltage source VS3 are added to the mode switching circuit MS1 shown in FIG. 7.

The mode switching circuit MS6 adjusts a value of the constant voltage supplied to the non-inverting input terminal of the comparator COMP1 according to the output voltage VOUT. Specifically, if the comparator COMP4 determines that the output voltage VOUT is lower than the constant voltage V3 output from the constant voltage source VS3, the switch SW1 selects a constant voltage V1′ output from the constant voltage source VS1′ and supplies it to the non-inverting input terminal of the comparator COMP1. The constant voltage V1′ is a voltage lower than the constant voltage V1. On the other hand, if the comparator COMP4 determines that the output voltage VOUT is not lower than the constant voltage V3 output from the constant voltage source VS3, the switch SW1 selects the constant voltage V1 output from the constant voltage source VS1 and supplies it to the non-inverting input terminal of the comparator COMP1.

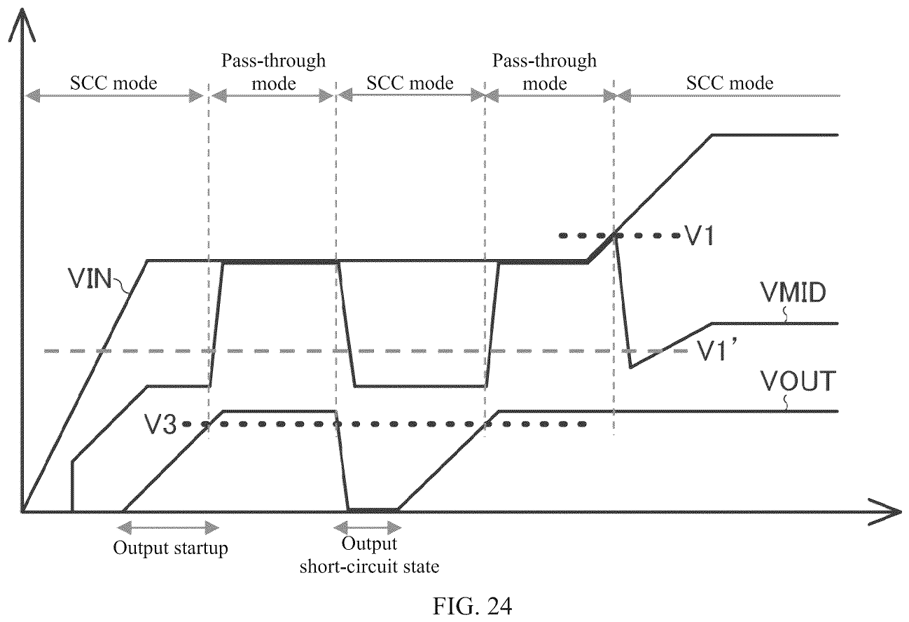

As a result, for example, as shown in FIG. 24, when the output voltage VOUT is low, such as during startup or when the output is short-circuited, etc., a range of operation in the SCC mode is widened, so that the power supply circuit 106 can reduce losses when the output voltage VOUT is low.

Furthermore, in this embodiment, a comparator having a hysteresis function may also be used instead of the comparator COMP1. Additionally, a delay may also be provided for the comparison result signal.

### Seventh Embodiment

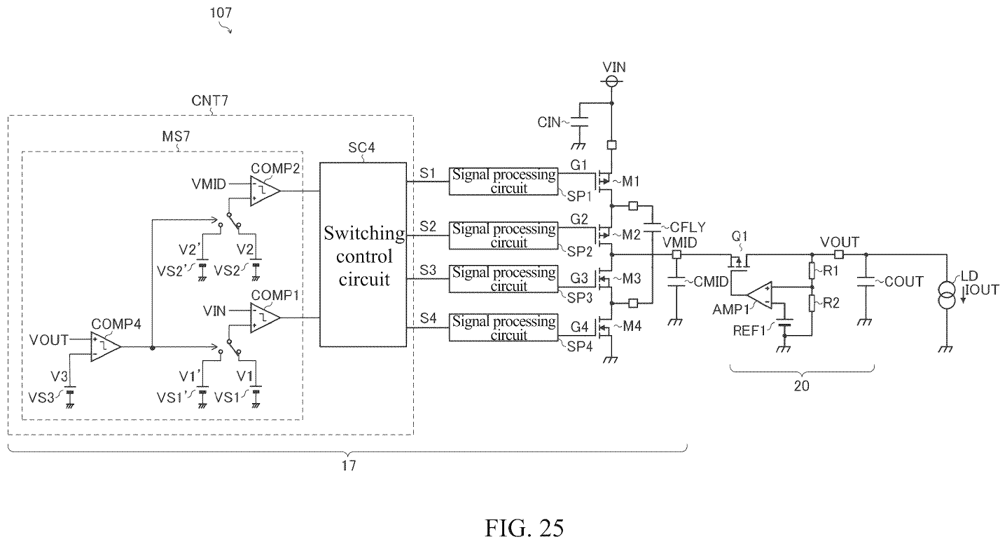

FIG. 25 is a diagram showing a configuration of a power supply circuit according to a seventh embodiment. In FIG. 25, the same parts as those in FIG. 19 are denoted by the same reference numerals, and detailed illustrations are omitted.

A power supply circuit 107 shown in FIG. 25 is configured such that the switched capacitor converter 14 in the power supply circuit 104 shown in FIG. 19 is replaced with a switched capacitor converter 17. That is, the power supply circuit 107 comprises the switched capacitor converter 17 and a linear power supply circuit 20 provided at a rear stage of the switched capacitor converter 17.

The switched capacitor converter 17 is configured such that the control circuit CNT4 in the switched capacitor converter 14 shown in FIG. 19 is replaced with a control circuit CNT7.

The control circuit CNT7 is configured such that the mode switching circuit MS4 in the control circuit CNT4 shown in FIG. 19 is replaced with a mode switching circuit MS7.

The mode switching circuit MS7 is configured such that a switch SW1, a constant voltage source VS1′, a switch SW2, a constant voltage source VS2′, a comparator COMP4, and a constant voltage source VS3 are added to the mode switching circuit MS4 shown in FIG. 19.

The power supply circuit 107 has a configuration that combines the power supply circuit 104 according to the fourth embodiment shown in FIG. 19 and the power supply circuit 106 according to the sixth embodiment shown in FIG. 23.

Furthermore, in the power supply circuit 107, both a value of the constant voltage supplied to the non-inverting input terminal of the comparator COMP1 and a value of the constant voltage supplied to the non-inverting input terminal of the comparator COMP2 are adjusted according to the output voltage VOUT, but it may be that only one of the value of the constant voltage supplied to the non-inverting input terminal of the comparator COMP1 and the value of the constant voltage supplied to the non-inverting input terminal of the comparator COMP2 is adjusted according to the output voltage VOUT.

Furthermore, in this embodiment, a comparator having a hysteresis function may also be used instead of the comparator COMP1. Additionally, a comparator having a hysteresis function may also be used instead of the comparator COMP2. Additionally, a delay may also be provided for each comparison result signal.

### Eighth Embodiment

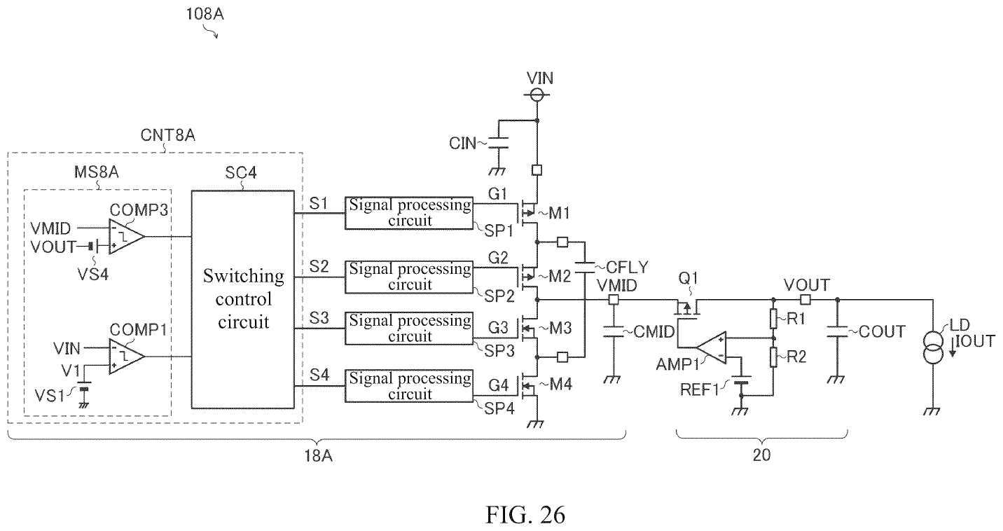

FIG. 26 is a diagram showing a first configuration example of a power supply circuit according to an eighth embodiment. In FIG. 26, the same parts as those in FIG. 19 are denoted by the same reference numerals, and detailed illustrations are omitted.

A power supply circuit 108A shown in FIG. 26 is configured such that the switched capacitor converter 14 in the power supply circuit 104 shown in FIG. 19 is replaced with a switched capacitor converter 18A. That is, the power supply circuit 108A comprises the switched capacitor converter 18A and a linear power supply circuit 20 provided at a rear stage of the switched capacitor converter 18A.

The switched capacitor converter 18A is configured such that the control circuit CNT4 in the switched capacitor converter 14 shown in FIG. 19 is replaced with a control circuit CNT8A.

The control circuit CNT8A is configured such that the mode switching circuit MS4 in the control circuit CNT4 shown in FIG. 19 is replaced with a mode switching circuit MS8A.

The mode switching circuit MS8A differs from the mode switching circuit MS4 shown in FIG. 19 in that the comparator COMP3 compares the intermediate voltage VMID with a voltage offset by a constant voltage source VS4 from the output voltage VOUT, but is otherwise similar to the mode switching circuit MS4 shown in FIG. 19.

The power supply circuit 108A shown in FIG. 26 achieves similar effects to those of the power supply circuit 104 according to the fourth embodiment shown in FIG. 19.

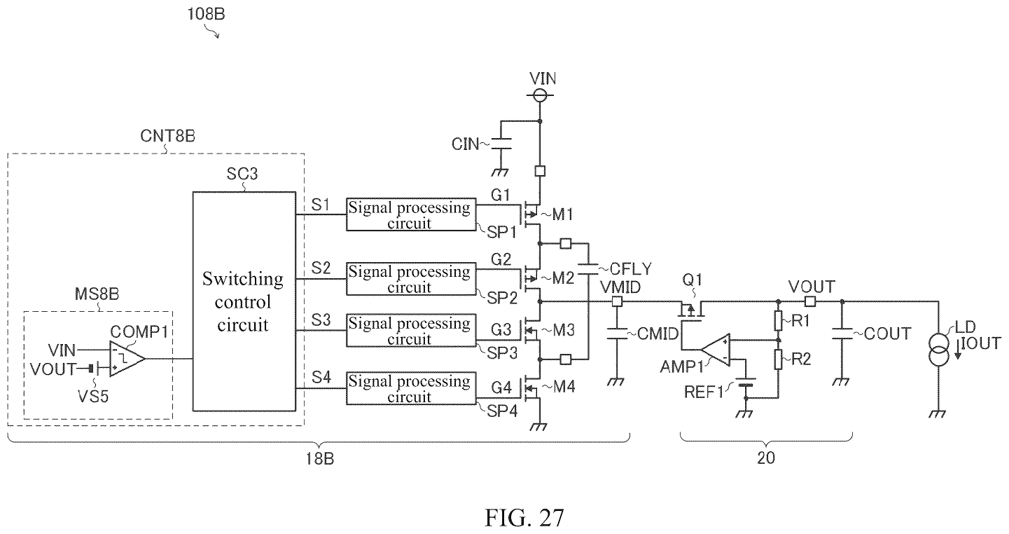

FIG. 27 is a diagram showing a second configuration example of a power supply circuit according to the eighth embodiment. In FIG. 27, the same parts as those in FIG. 7 are denoted by the same reference numerals, and detailed illustrations are omitted.

A power supply circuit 108B shown in FIG. 27 is configured such that the switched capacitor converter 11 in the power supply circuit 101 shown in FIG. 7 is replaced with a switched capacitor converter 18B. That is, the power supply circuit 108B comprises the switched capacitor converter 18B and a linear power supply circuit 20 provided at a rear stage of the switched capacitor converter 18B.

The switched capacitor converter 18B is configured such that the control circuit CNT1 in the switched capacitor converter 11 shown in FIG. 7 is replaced with a control circuit CNT8B.

The control circuit CNT8B is configured such that the mode switching circuit MS1 in the control circuit CNT1 shown in FIG. 7 is replaced with a mode switching circuit MS8B.

The mode switching circuit MS8B differs from the mode switching circuit MS1 shown in FIG. 7 in that the comparator COMP1 compares the input voltage VIN with a voltage offset by a constant voltage source VS5 from the output voltage VOUT, but is otherwise similar to the mode switching circuit MS1 shown in FIG. 7.

The power supply circuit 108B shown in FIG. 27 achieves similar effects to those of the power supply circuit 104 according to the fourth embodiment shown in FIG. 19. Additionally, since a threshold value for determination by the comparator COMP1 naturally decreases when the output voltage VOUT is low, the power supply circuit 108B shown in FIG. 27 achieves similar effects to those of the power supply circuit 105 according to the fifth embodiment shown in FIG. 22.

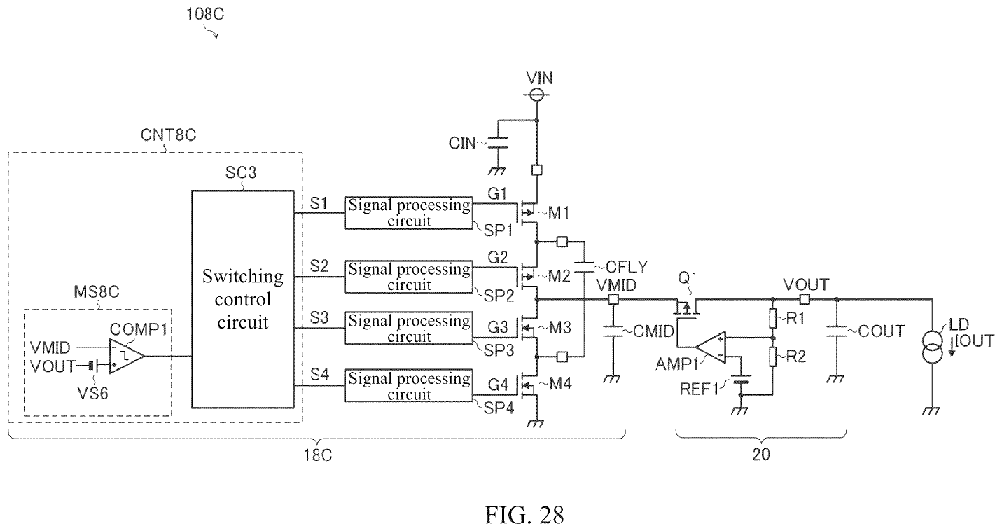

FIG. 28 is a diagram showing a third configuration example of a power supply circuit according to the eighth embodiment. In FIG. 28, the same parts as those in FIG. 7 are denoted by the same reference numerals, and detailed illustrations are omitted.

A power supply circuit 108C shown in FIG. 28 is configured such that the switched capacitor converter 11 in the power supply circuit 101 shown in FIG. 7 is replaced with a switched capacitor converter 18C. That is, the power supply circuit 108C comprises the switched capacitor converter 18C and a linear power supply circuit 20 provided at a rear stage of the switched capacitor converter 18C.

The switched capacitor converter 18C is configured such that the control circuit CNT1 in the switched capacitor converter 11 shown in FIG. 7 is replaced with a control circuit CNT8C.

The control circuit CNT8C is configured such that the mode switching circuit MS1 in the control circuit CNT1 shown in FIG. 7 is replaced with a mode switching circuit MS8C.

The mode switching circuit MS8C differs from the mode switching circuit MS1 shown in FIG. 7 in that the comparator COMP1 compares the intermediate voltage VMID with a voltage offset by a constant voltage source VS6 from the output voltage VOUT, but is otherwise similar to the mode switching circuit MS1 shown in FIG. 7.

The power supply circuit 108C shown in FIG. 28 achieves similar effects to those of the power supply circuit 104 according to the fourth embodiment shown in FIG. 19. Additionally, since the threshold value for determination by the comparator COMP1 naturally decreases when the output voltage VOUT is low, the power supply circuit 108C shown in FIG. 28 achieves similar effects to those of the power supply circuit 105 according to the fifth embodiment shown in FIG. 22.

Furthermore, in the power supply circuit 108A, a comparator having a hysteresis function may also be used instead of the comparator COMP1. Additionally, a comparator having a hysteresis function may also be used instead of the comparator COMP3. Additionally, a delay may also be provided for each comparison result signal.

Additionally, in each of the power supply circuits 108B and 108C, a comparator having a hysteresis function may also be used instead of the comparator COMP1. Additionally, a delay may also be provided for each comparison result signal.

Furthermore, in the power supply circuits 108A to 108C, modifications similar to those in FIG. 10 to FIG. 14 may also be applied.

### Application Examples

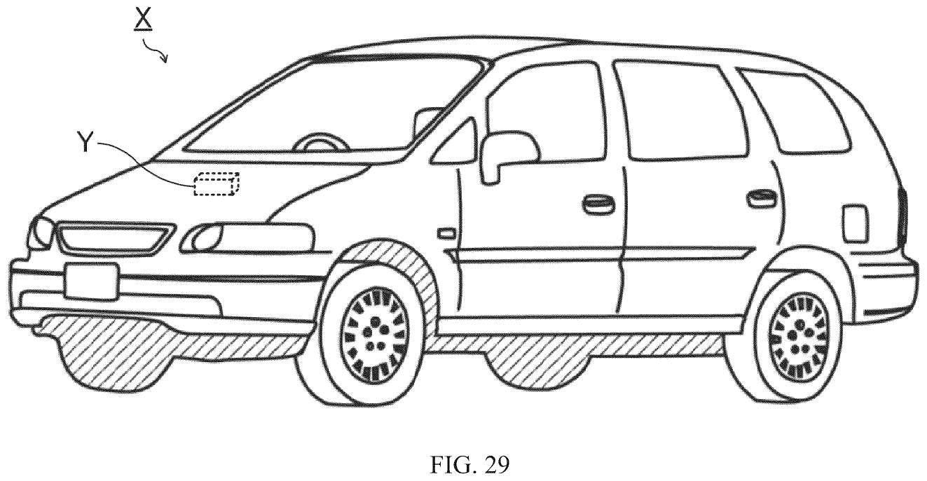

Each of the power supply circuits 101 to 107 and 108A to 108C is incorporated into an electronic apparatus Y installed in a vehicle X as shown in FIG. 29. Furthermore, the installation position of the electronic apparatus Y in FIG. 29 may differ from an actual position for illustrative convenience. Additionally, each of the power supply circuits 101 to 107 and 108A to 108C is not limited to use in an automotive field and can be incorporated into an electronic apparatus used in various fields (such as an automotive field, an industrial machinery field, a home appliance field, etc.).

### Others

The above embodiments should be considered in all respects as illustrative and not restrictive, the technical scope of the present disclosure is defined by the claims rather than the above illustrations of the embodiments, and should be understood to include all modifications that falls within the meaning and scope of claims and equivalents.

For example, unless contradictory, matters described in any embodiment among multiple embodiments can be applied to any other embodiment (i.e., it is possible to combine any two or more embodiments among multiple embodiments).

For example, in each of the above embodiments, an NMOS transistor may also be used instead of the PMOS transistor M1. Furthermore, when an NMOS transistor is used instead of the PMOS transistor M1, logical inversion in the signal processing circuit SP1 is unnecessary.

For example, in each of the above embodiments, an NMOS transistor may also be used instead of the PMOS transistor M2. Furthermore, when an NMOS transistor is used instead of the PMOS transistor M2, logical inversion in the signal processing circuit SP2 is unnecessary.

For example, in each of the above embodiments, a switch element other than a MOS transistor may also be used as a switch element of a switched capacitor converter. As a switch element other than a MOS transistor, a bipolar transistor can be mentioned, for example.

For example, in each of the above embodiments, an NMOS transistor or a bipolar transistor may also be used instead of the PMOS transistor Q1 as an output transistor of the linear power supply circuit 20.

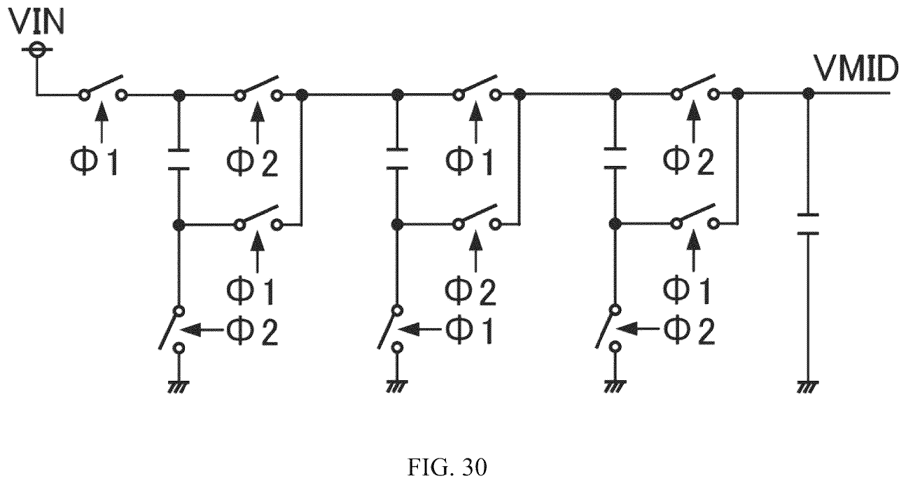

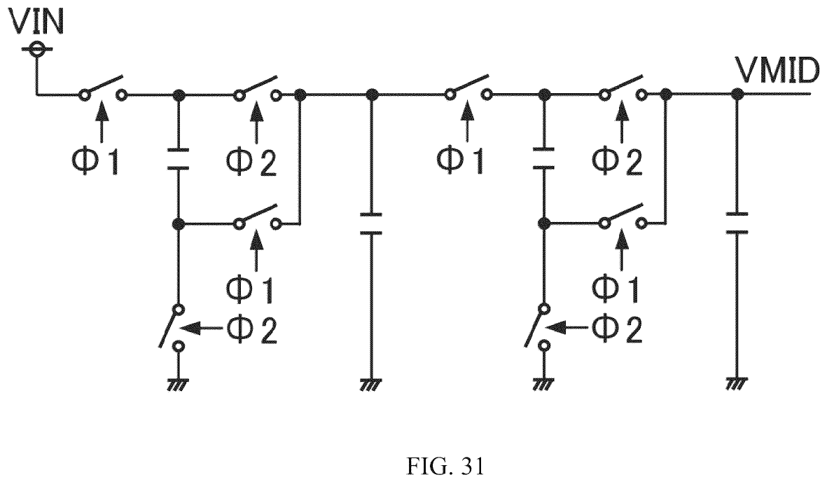

The topology of the switched capacitor converter is not limited to each of the above embodiments. For example, the switched capacitor converter shown in FIG. 30, the switched capacitor converter shown in FIG. 31, etc. may also be used. In the switched capacitor converter shown in FIG. 30 and the switched capacitor converter shown in FIG. 31, in the SCC mode, when a control signal Φ1 is a signal indicating on, a control signal Φ2 becomes a signal indicating off, and when the control signal Φ1 is a signal indicating off, the control signal Φ2 becomes a signal indicating on.

### Appendix

Appendices are provided for the present disclosure, for which specific configuration examples are shown in the above embodiments.

A control circuit (CNT1) of the present disclosure is configured that the control circuit is configured to be used as part of a switched capacitor converter (11), which comprises a plurality of switch elements (M1 to M4) and at least one capacitor (CFLY), and is configured to generate a second voltage from a first voltage, comprising a mode switching circuit (MS1) configured to switch between a first mode and a second mode, wherein the first mode is a mode in which switching control of the plurality of switch elements is stopped to set the second voltage to a voltage value that can be regarded as the same as the first voltage, and the second mode is a mode in which the plurality of switch elements is switching-controlled to set the second voltage to a voltage value lower than the first voltage (first configuration).

Since the control circuit of the above first configuration can put the switched capacitor converter into the first mode, in a power supply circuit that comprises the switched capacitor converter and a linear power supply circuit provided at a rear stage of the switched capacitor converter, an increase in a startup voltage and an increase in an input voltage that enables an output voltage to be output as per a set voltage can be suppressed.

Furthermore, since the control circuit of the above first configuration can put the switched capacitor converter into the second mode, losses in a power supply circuit that comprises the switched capacitor converter and a linear power supply circuit provided at a rear stage of the switched capacitor converter can be reduced.

The control circuit of the above first configuration may be configured so that the mode switching circuit is configured to switch from the first mode to the second mode when the first voltage changes from less than or equal to a first threshold to greater than the first threshold (second configuration).

The control circuit of the above second configuration may be configured so that the mode switching circuit is configured to adjust the first threshold according to an output current of the switched capacitor converter (third configuration).

The control circuit of the above second or third configuration may be configured so that the mode switching circuit is configured to switch from the second mode to the first mode when the first voltage changes from a state greater than a second threshold to be equal to or less than the second threshold, and the second threshold is less than the first threshold (fourth configuration).

The control circuit of any of the above first to third configurations may be configured so that the mode switching circuit is configured to switch from the first mode to the second mode according to the first voltage, and switch from the second mode to the first mode according to the second voltage (fifth configuration).

The control circuit of the above first configuration may be configured so that the mode switching circuit is configured to switch between the first mode and the second mode according to the second voltage (sixth configuration).

The control circuit of any of the above first to sixth configurations may be configured so that the mode switching circuit is configured to provide a delay in mode switching (seventh configuration).

A power supply circuit (101 to 107, 108A to 108C) of the present disclosure is configured that the power supply circuit comprises a switched capacitor converter (11 to 17, 18A to 18C) comprising the control circuit of any of the above first to seventh configurations, the plurality of switch elements, and the at least one capacitor; and a linear power supply circuit (20) configured to generate a third voltage from the second voltage (eighth configuration).

The power supply circuit of the above eighth configuration may be configured so that the switched capacitor converter comprises the control circuit of the above second configuration, and the mode switching circuit (MS6, MS7) is configured to adjust the first threshold according to the third voltage (ninth configuration).

The power supply circuit of the above ninth configuration may be configured so that the mode switching circuit (MS7) is configured to switch from the second mode to the first mode according to a magnitude relationship between the second voltage and a third threshold, and is configured to adjust the third threshold according to the third voltage (tenth configuration).

The power supply circuit of the above eighth configuration may be configured so that the switched capacitor converter comprises the control circuit of the above first configuration, and the mode switching circuit (MS8C) is configured to switch between the first mode and the second mode according to a magnitude relationship between the second voltage and the third voltage (eleventh configuration).

An electronic apparatus (Y) of the present disclosure has a configuration wherein the electronic apparatus comprises the power supply circuit of any of the above eighth to eleventh configurations (twelfth configuration).

1. A control circuit, configured to be used as part of a switched capacitor converter, which comprises a plurality of switch elements and at least one capacitor, and is configured to generate a second voltage from a first voltage, comprising:
a mode switching circuit configured to switch between a first mode and a second mode,
wherein the first mode is a mode in which switching control of the plurality of switch elements is stopped to set the second voltage to a voltage value that can be regarded as the same as the first voltage, and
the second mode is a mode in which the plurality of switch elements is switching-controlled to set the second voltage to a voltage value lower than the first voltage.

2. The control circuit of claim 1, wherein the mode switching circuit is configured to switch from the first mode to the second mode when the first voltage changes from less than or equal to a first threshold to greater than the first threshold.

3. The control circuit of claim 2, wherein the mode switching circuit is configured to adjust the first threshold according to an output current of the switched capacitor converter.

4. The control circuit of claim 2, wherein the mode switching circuit is configured to switch from the second mode to the first mode when the first voltage changes from a state greater than a second threshold to be equal to or less than the second threshold, and the second threshold is less than the first threshold.

5. The control circuit of claim 1, wherein the mode switching circuit is configured to switch from the first mode to the second mode according to the first voltage, and switch from the second mode to the first mode according to the second voltage.

6. The control circuit of claim 1, wherein the mode switching circuit is configured to switch between the first mode and the second mode according to the second voltage.

7. The control circuit of claim 1, wherein the mode switching circuit is configured to provide a delay in mode switching.

8. A power supply circuit, comprising:
a switched capacitor converter comprising the control circuit of claim 1, the plurality of switch elements, and the at least one capacitor; and
a linear power supply circuit configured to generate a third voltage from the second voltage.

9. The power supply circuit of claim 8, wherein the mode switching circuit is configured to switch from the first mode to the second mode when the first voltage changes from less than or equal to a first threshold to greater than the first threshold, and the mode switching circuit is configured to adjust the first threshold according to the third voltage.

10. The power supply circuit of claim 9, wherein the mode switching circuit is configured to switch from the second mode to the first mode according to a magnitude relationship between the second voltage and a third threshold, and is configured to adjust the third threshold according to the third voltage.

11. The power supply circuit of claim 8,
wherein the mode switching circuit is configured to switch between the first mode and the second mode according to a magnitude relationship between the second voltage and the third voltage.

12. An electronic apparatus, comprising the power supply circuit of claim 8.
